(19) United States
(12) Patent Application Publication
(10) Pub. No.: US 2007/0291582 A1
(43) Pub. Date: Dec. 20, 2007

(54) Apparatus and method for producing a component mixture from at least two components

(75) Inventor: Matthias Feil, Bad Boll (DE)

Correspondence Address: POSZ LAW GROUP, PLC, 12040 SOUTH LAKES DRIVE, SUITE 101, RESTON, VA, 20191, US

(73) Assignee: SCHMIDT & HEINZMANN GmbH & Co. KG, Bruchsal (DE)

(21) Appl. No.: 11/892,206

(22) Filed: Aug. 21, 2007

(30) Foreign Application Priority Data
Jun. 2, 2006 (DE) DE 102006026254.9

(51) Int. Cl. B01F 15/02

(52) U.S. Cl. 366/160.2; 366/173.1

(57) ABSTRACT

An apparatus for producing a component mixture from at least two components with at least one inlet duct to feed or apply at least one component, a conveying duct to conduct the component mixture and at least one outlet duct to collect the component mixture. With the aim of providing an apparatus and an associated process that permit not only easy cleaning of the apparatus but also extremely uniform metering and in particular a wide control range, as well as good mixing of the components, the conveying duct is configured as a circuit to enable the component mixture stream to circulate in the conveying duct circuit of the apparatus.

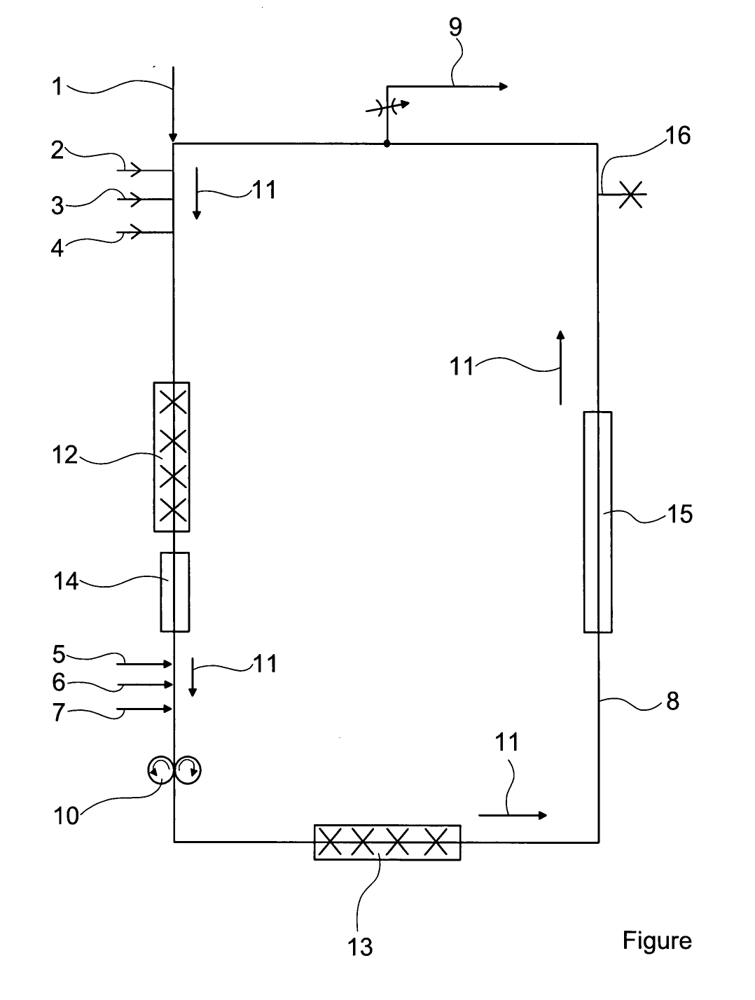

### TECHNICAL FIELD

The invention relates generally to production of component mixtures, and in particular to an apparatus and method for producing a component mixture from at least two components.

### BACKGROUND

The mixing of plastic mixtures to produce semifinished products, in particular through a sheet molding compound (SMC) process, usually takes place batchwise in large containers. This often fails to achieve sufficient and uniform mixing of the components. Undesired demixing of the components also often takes place. Furthermore, the cleaning of these containers is very complicated.

WO 2004/094122 A1 discloses a process to mix polymer melts with additives. This is a continuous process in which the additives are added to a principal stream composed of a polymer melt and in particular directly thereafter are mixed in a static mixer with the principal stream.

However, conventional component mixing apparatuses are often not easy to clean, and do not provide uniform metering, a wide control range and good mixing of the components.

### SUMMARY

In view of the above, it is an object to provide a mixing apparatus and associated process that permit not only easy cleaning of the apparatus but also extremely uniform metering, a wide control range and good mixing of the components.

A substantial advantage of the apparatus is in the wide control range of the apparatus, which provides a closed circuit in which there is a component mixture volume flow rate designed for a maximum collection rate. If the amount of the component mixture collected is not 100%, the remainder of the component mixture continues to circulate within the circuit.

Ambient influences, such as atmospheric moisture, normally affect the quality of the components. The apparatus advantageously shields the components from these disruptive influences by virtue of its closed design.

Ingress of air into the apparatus is advantageously avoided, since it involves a closed system and a closed conveying duct, and the components are the only material introduced into the conveying duct.

The apparatus advantageously permits ideal treatment of the components, and in particular treatment of reactive components which are temperature-sensitive, since there can be not only cooling zones but also heating zones provided within the conveying duct.

By virtue of the extremely uniform metering and in particular of the wide control range, and also the good mixing of the components in the closed system, the apparatus advantageously permits exact feeding of components in very small amounts, in particular down to values of 0.05%.

After any interruption of production caused by defective operation, easy cleaning of the apparatus is advantageously possible, since all that is needed for this is flushing of the conveying duct with a component suitable for this purpose.

Further embodiments and advantages will become apparent from the claims and from the description.

### BRIEF DESCRIPTION OF THE DRAWING

The invention is further illustrated below by an exemplary embodiment in the attached FIGURE. The figure, the description and the claims contain numerous features in combination, and a person skilled in the art will also find it useful to consider these individually and in combination.

### DETAILED DESCRIPTION

The single figure shows an apparatus to produce a component mixture from at least two components. The apparatus is preferably used to mix different liquid components (e.g. resins, additives, fillers), and in particular to produce plastics in a sheet molding compound (SMC) semi-finished product process. However, the components can also just as well involve powder or liquids and powder.

The apparatus has a plurality of inlets 1-7 to introduce individual components or component mixtures, and the inlets 1-7 are preferably ducts. In the present inventive example, a first inlet duct 1 serves to introduce a main resin and the further inlet ducts 2-7 serve to introduce resins and additives. The main resin alone can also, as explained in more detail below, serve to flush the apparatus. The inlet ducts 1-7 open into a conveying duct 8 which serves to conduct the components introduced or the component mixture introduced. The introduction or the infeed of the components preferably takes place by means of metering pumps (not shown). The respective metering pump or the respective metering system is selected in accordance with the component to be metered.

For collection, i.e. for removal of the component mixture from the conveying duct 8, the apparatus has an outlet 9, preferably formed as a duct. The outlet duct 9 preferably has pressure control and functions here on the overflow principle, and the component mixture collected here can then be introduced into further processing (not shown).

With the aim of providing an apparatus which permits not only easy cleaning but also extremely uniform metering and good mixing of the components, the conveying duct 8 in the present exemplary embodiment the is a circuit, i.e. a closed circuit or closed mixing circuit, that has been designed at least for a maximum rate of collection of the component mixture. A maximum collection rate here refers to the maximum required amount of component mixture (weight per unit of time) that can be removed from the conveying duct 8. Accordingly, the volume flow rate of the conveying duct 8 is the same as or preferably greater than the volume flow rate of the maximum amount of component mixture to be collected. Ideally, the conveying duct 8 has been designed for a volume flow rate which is greater, by a factor of from 1.05 to 40, than the volume flow rate of the required component mixture. In principle, the overflow rate is also restricted to the amount, or flow rate, of infeed.

In the conveying duct 8, at least one continuously operating conveying pump 10 is provided, and circulates the component mixture in the conveying duct 8. It is preferable here to use a gear pump. The volume flow rate of the component mixture in the conveying duct 8 is controllable by way of a pressure difference between the suction side and the pressure side of the conveying pump 10 or in accordance with the suction pressure of the conveying pump 10, and the control range of the conveying pump 10 here is smaller than the control range of the component mixture flow rate.

The inlet duct(s) 1-7 can be provided in the direction of flow 11 between the outlet duct 9 to collect the component mixture and the conveying pump 10 and/or between the conveying pump 10 and the outlet duct 9.

Two mixing elements 12 and 13 may be provided in the conveying duct 8 to give good and uniform mixing of the components, and the arrangement of the mixing element(s) 12 and 13 here can be in the direction of flow 11 between the outlet duct 9 and the conveying pump 10 and/or between the conveying pump 10 and the outlet duct 9. In the present exemplary embodiment, the first mixing element 12 serves for premixing, in order that, for example, a hardener and accelerator are not combined without mixing. The mixing element 12 can include a static mixer, a dynamic mixer and/or a dispersing mixer.

Ideally, a respective portion of the inlet ducts 1-7 is provided upstream of the two mixing elements 12, 13, so that mixing of the components takes place immediately after their infeed. In particular in the case of infeed of a plurality of components reacting with one another, these should be introduced in succession with intervening mixing elements. The overflow principle requires that if, by way of example, the amount of component infeed has the value 1 and the amount of component mixture circulating has the value 10, the amount of component mixture escaping at the outlet duct 9 comprises 10% which has passed through the mixing elements 12 and 13 only once and 90% which has passed two or more times through these mixing elements. The consequence of this is greater homogeneity of mixing, and with this the conveying cross section of the conveying duct 8, designed for the maximum component mixture volume flow rate, has no adverse effect for a small metering rate.

To optimize treatment of temperature-sensitive components, not only a heating zone 14 but also a cooling zone 15 have been provided in the conveying duct 8.

In order to permit deaeration of the conveying duct 8, a deaeration aperture 16 has been provided, by way of which undesirable gases can be passed out of the system. In the present exemplary embodiment, the apparatus has a horizontal orientation, but an apparatus with vertical orientation or an apparatus with not only horizontal but also vertical sections would also be conceivable here. In the case of an apparatus with vertical orientation, it is preferable that at least one geodetically upper deaeration aperture has been provided to pass gases out of the conveying duct circuit 8.

There is moreover a conceivable mixing system which is composed of individual apparatuses or, respectively, mixing circuits installed together in a cascaded manner, and which is therefore composed of a plurality of mixing circuits connected to one another, where the component mixture of the first mixing circuit passes by way of a connection, in accordance with the overflow principle, into a second mixing circuit. The overflow component mixture from the first mixing circuit is therefore a component to be introduced to the subsequent second mixing circuit.

The apparatus makes it possible to conduct a process in which, according to the present exemplary embodiment, a component mixture stream circulates in the conveying duct circuit 8 of the mixing apparatus, and in the event of collection of less than 100% of the component mixture, the remainder of the component mixture continues to circulate in the conveying duct circuit 8.

Prior to start-up, a starting component is advantageously charged to the apparatus with the aim of deaerating the conveying duct 8, thus conducting any gases present out of the conveying duct 8. A formulation mixture is then charged to the apparatus or to the conveying duct 8, and by this stage has a substantially correct mixing ratio in accordance with the component mixture to be produced, thus then passing the starting component out of the conveying duct 8.

During the mixing of reactive components, in the event of a prolonged stoppage of the apparatus, the conveying duct 8 can advantageously be flushed with an unreactive component, for example the principal resin.

The introduction or infeed of the components by way of the inlet ducts 1-7 preferably takes place continuously. With the aim of avoiding droplet formation in the region of inlet duct(s) 1-7, specific flow rates can be produced. In the region of the smallest item component inlets, droplet formation is preferably avoided via high flow velocity, with the aim of achieving continuous infeed. The infeed of each component takes place in accordance with a formulation, its minimum value being 0.05%. In the case of introduction of a plurality of components, the introduction of each individual component preferably takes place respectively prior to mixing elements 12 and 13.

In order to optimize the result of mixing, certain pressures and/or eddy effects can be specifically produced in individual regions of the conveying duct 8. The pressure-controlled regions can be produced by way of the conveying action of the conveying pump 10 and/or the circulating pressure of the component mixture in the conveying duct 8. With the aim of permitting ideal introduction of components, regions in the vicinity of inlet duct(s) 1-7 preferably have a low pressure. With the aim of optimizing the mixing of the components, the other regions preferably have a relatively high pressure.

The invention is described herein in detail with particular reference to presently preferred exemplary embodiments. However, it will be understood that variations and modifications can be effected within the scope and spirit of the invention.

What is claimed is:

1. An apparatus for producing a component mixture, comprising:
at least one inlet duct to feed at least one component;
a conveying duct to conduct the component mixture; and
at least one outlet duct to collect the component mixture, wherein
the conveying duct is configured as a circuit.

2. The apparatus according to claim 1, wherein the conveying duct is configured for a component mixture volume flow rate which is the same as or greater than a volume flow rate of a maximum amount of the component mixture to be collected.

3. The apparatus according to claim 1, further comprising at least one continuously operating pump provided in the conveying duct for circulating the component mixture in the conveying duct.

4. The apparatus according to claim 3, wherein the volume flow rate of the component mixture is controllable by way of a pressure difference between a suction side and a pressure side of the pump or in accordance with a suction pressure of the pump.

5. The apparatus according to claim 3, wherein a control range of the pump is smaller than a control range of a component mixture flow rate.

6. The apparatus according to claim 1, wherein the outlet duct is subject to pressure control.

7. The apparatus according to claim 1, further comprising at least one mixing element provided in the conveying duct.

8. The apparatus according to claim 7, wherein at least one inlet duct is located in a region of the mixing element.

9. The apparatus according to claim 7, wherein a plurality of mixing elements are provided, between each of which an inlet duct is located.

10. The apparatus according to claim 1, further comprising at least one heating zone and/or at least one cooling zone located in the conveying duct.

11. The apparatus according to claim 1, further comprising at least one deaeration aperture located in the conveying duct.

12. The apparatus according to claim 1, wherein the apparatus is configured in at least one of a horizontal and a vertical orientation.

13. The apparatus according to claim 11, wherein the apparatus is configured in a vertical orientation, and the at least one deaeration aperture comprises at least one geodetically upper deaeration aperture to pass gases out of the conveying duct circuit.

14. A mixing system, comprising:
a plurality of apparatuses each for producing a component mixture, each comprising
at least one inlet duct to feed at least one component,
a conveying duct to conduct the component mixture, and
at least one outlet duct to collect the component mixture, wherein
the conveying duct is configured as a circuit and the plurality of apparatuses are installed in series so that a component mixture from a preceding apparatus is fed to a subsequent apparatus.

15. A method for operating an apparatus to produce a component mixture from a plurality of components, the apparatus including at least one inlet duct to feed at least one component, a conveying duct circuit to conduct the component mixture, and at least one outlet duct to collect the component mixture, the method comprising:
conducting at least one component within the conveying duct circuit;
subsequently applying a further component by way of the at least one inlet duct;
collecting the component mixture by way of the at least one outlet duct; and
circulating a component mixture stream in the conveying duct circuit.

16. The method according to claim 15, further comprising continuing to circulate a remainder of the component mixture in the conveying duct in the event of collection of less than 100% of the component mixture.

17. The method according to claim 15, further comprising:
providing a mixing apparatus in the conveying duct;
on start-up of the mixing apparatus, charging a starting component to the conveying duct, thus causing discharge of gases located in the conveying duct;
after discharge of the gases, charging the component mixture to the conveying duct, thus causing the starting component to be passed out of the conveying duct; and
during further operation of the mixing apparatus, feeding additional components into the mixing apparatus.

18. The method according to claim 15, wherein the subsequently applying a further component by way of the at least one inlet duct comprises subsequently and continuously applying the further component by way of the at least one inlet duct.

19. The method according to claim 15, further comprising producing specific component flows to avoid droplet formation in the region of the at least one inlet duct.

20. The method according to claim 15, wherein the subsequently applying a further component takes place according to a formulation and has a minimum value of 0.05%.

21. The method according to claim 15, wherein a plurality of components are applied upstream of a mixing element.

22. The method according to claim 15, wherein the plurality of components are present in pulverulent and/or liquid form.

23. The method according to claim 15, further comprising producing specific pressures and/or turbulences in individual pressure-controlled regions of the conveying duct circuit.

24. The method according to claim 23, wherein the pressure-controlled regions of the conveying duct circuit have a lower pressure to enable feeding of the plurality of components.

25. The method according to claim 23, wherein the pressure-controlled regions of the conveying duct circuit have a higher pressure to improve mixing of the plurality of components.

26. The method according to claim 15, further comprising flushing the conveying duct with an unreactive component during a prolonged process interruption.
